(19) United States
(12) Patent Application Publication
(10) Pub. No.: US 2014/0002306 A1
(43) Pub. Date: Jan. 2, 2014

(54) DIRECTIONAL RADIO SIGNAL DETECTION APPARATUS AND METHODS OF USE

(71) Applicant: Son Thach Nguyen, Westminster, CO (US)

(72) Inventor: Son Thach Nguyen, Westminster, CO (US)

(21) Appl. No.: 14/028,113

(22) Filed: Sep. 16, 2013

Related U.S. Application Data
(63) Continuation-in-part of application No. 13/394,722, filed on Mar. 7, 2012.

(51) Int. Cl. G01S 3/14

(52) U.S. Cl. CPC G01S 3/143
USPC 342/443; 342/442

(57) ABSTRACT

An apparatus for direction-finding a received radio signal is disclosed. The receiving apparatus selectively receives on a predetermined frequency to match the transmitter frequency. The receiving apparatus comprises of two or three antennas, including one or two loop antennas that work in conjunction with a third reference antenna (whose phase does not vary when its orientation changes relative to the transmitter) such as a dipole, monopole or helical antenna. By comparing the phase between the antennas the direction of the incoming RF signal can be determined. In some embodiments, the windings of the two loop antennas are wound in reverse with respect to each other in order to substantially double the sensitivity of the signal-detection capabilities.

The present application is a Continuation-In-Part of, and claims priority to, U.S. patent application Ser. No. 13/394,722 filed Mar. 7, 2012, which is a US national stage entry of PCT/US11/30403 filed Mar. 11, 2011. The present application and the priority applications cited above have a common inventor.

### BACKGROUND

Directional radio-signal detectors are used in conjunction with radio-signal-emitting beacons in order to determine the physical locations of vehicles or persons carrying such beacons. For example, Emergency Position-Indicating Radio Beacons (EPIRBs) are used with ships and boats, Emergency Location Transmitters (ELTs) are often incorporated in aircraft, and individuals may carry a Personal Locator or other similar portable or hand-held device. For such devices to be effective for those relying on them for safety reasons, there is a requirement that the directional radio-signal equipment used to find the beacons be relatively small, accurate, easy-to-use, and be able to provide unambiguous direction determinations.

Direction finding (DF) systems can be classified as having one antenna or multiple antennas. Some of the most popular and simplest methods use single-directional antennas such as Yagis (that is, a directional antenna comprising an array of dipoles coupled with various parasitic elements) or loop (single or multi-turn) antennas. With a single-turn and multiple-turn loop antennas, there is an ambiguity of 180 degrees. Yagi antennas also can give ambiguous direction since the antenna response is symmetric compared to the maximum signal strength direction. To determine the direction of the signal, the Yagi antenna must be rotated. Loop antennas give ambiguous direction and cannot be resolved even when rotated since there are two points where with maximum signal strength occur.

In varying signal conditions, such as in a man-overboard situation, wherein the received signal strength is varying or the beam width of a directional antenna is large, the maximum signal level can be hard to determine. Thus these devices have low precision and accuracy.

Prior art has also used the method of a single loop antenna or two loop antennas and single reference antenna, typically a monopole or dipole antenna. Patents such as U.S. Pat. No. 4,528,566, Tyler et al., or U.S. Pat. No. 3,106,710, Stover, or U.S. Pat. No. 4,306,240, Yasuda et al., or U.S. Pat. No. 4,307,402, Watanabe combine the signal from a loop and a dipole antenna using a summing circuit to create a coupled antenna that has a unidirectional amplitude response. Stover also combines the signals from both loop antennas in a summing circuit to create a coupled antenna that has a unidirectional amplitude response. In all of these, the output of one antenna is summed with that of another in order to create an antenna with a unidirectional amplitude response which is used to make a goniometer. The phase of the received electromagnetic energy is not used. In all of these, to determine the direction of the source of electromagnetic energy the antenna structure needs to have a directional amplitude response. This is a natural conclusion, but not a necessary one. In fact, if the phase of the received electromagnetic energy is used, a variety of benefits can be obtained, as will be discussed below (U.S. Pat. No. 7,298,314, Schantz et al., as well as the present disclosure).

Tyler teaches the following:

“A one half wave delay line in the receiver is responsive to the signal detected by a directional antenna for generating a 180 degree out-of-phase signal with respect to the signal detected by a sense antenna . . . a summation signal representing the summation of the 180 degree out-of-phase signal and the signal detected by the sense antenna” indicates the direction of the source of electromagnetic energy. The summation of a loop directional antenna with a dipole sense antenna creates a cardioid amplitude response pattern and thus resolves the 180 degree ambiguity.

Stover teaches summing two loop antennas, one loop antenna positioned 90 degree relative to the other loop antenna, to avoid the use of a dipole antenna when determining the direction of a source of electromagnetic energy. Avoiding the use of dipole antennas avoids electric field disturbances, as loop antennas can be shielded from electrical fields. Stover, however, still requires the summation of one of the loop antennas with a dipole antenna to resolve the 180 degree ambiguity of the directional loop antennas.

Yasuda teaches imparting amplitude modulation to two loop antennas so that when their output signals are summed with the reference antenna's signal the amplitude modulation converts to phase modulation, and as such the summed signals can be demodulated by a single frequency modulation receiver. Direction is still determined by the amplitude response pattern of the summed signals.

Watanabe teaches using two orthogonally disposed loop antennas and alternately summing the first loop antenna with a reference antenna and summing the second loop antenna with a reference antenna and comparing the two. In such a fashion variations in phase shift between the reference antenna and the loop antennas can be compensated. This phase shift must be just the correct amount so that when the outputs of the antennas are added the resultant antenna structure is as directional as possible in its amplitude response.

Other prior art such as U.S. Pat. No. 3,967,280, Mayer, or U.S. Pat. No. 4,489,327, Eastwell, or U.S. Pat. No. 4,121,216, Bunch, incorporates improvements but does not deviate from the basic thinking that to determine the direction of the source of electromagnetic energy the antenna structure needs to have a directional amplitude response: that is its amplitude response must vary depending on the direction from which the electromagnetic energy is coming from.

Mayer teaches imposing modulation onto the antenna outputs so that they can be combined close to the antennas, rather than at the remote receiver unit. But the combining is still a summation which results in a antenna structure with a directional amplitude response.

Eastwell teaches selectively summing the antenna outputs so that the direction of the source of electromagnetic energy can be determined, to within one of four quadrants, without having to rotate the antenna structure.

Bunch teaches “translating bearing amplitude information into phase comparison data for unambiguous angular measurement between a reference and an emitting radiation source” using sum and difference combiners. This incorporates properties of Yasuda and Eastwell, in that it eliminates the need to either mechanically (or electrically) rotate the directional antenna structure, while still preserving the same advantage which Yasuda enjoys, in the ability to use FM receivers with limiting amplifiers. Limiting amplifiers are insensitive to amplitude, which is why Bunch converts the amplitude signal into a phase difference prior to passing it to the receiver. However, the direction determination is still performed by the amplitude variation in the antenna response depending on the direction from which the electromagnetic energy is coming from, as is stated in column 1, line 46: “Bearing information from the two orthogonally mounted vertical loop antennas is derived from the relative amplitude of the two vertical loop signals.”

It is not until the prior art of U.S. Pat. No. 7,298,314, Schantz et al., where phase is first taught in the determination of range. However, Schantz teaches the use of phase to determine range, not direction, and only in the near field. In so doing, Schantz uses a structure entirely different from that of the present invention. As does all prior art, Schantz still teaches the use of “small loop antennas that behave like a time domain magnetic dipole”. This is a necessary requirement for the apparatus described by Schantz to work. These antennas are used to separate the magnetic field from the electric field. The present disclosure teaches that such antennas are undesirable and overcomes them. Furthermore, the present disclosure has to do only with electromagnetic energy in the far field. This is an entirely different field of application from Schantz, which has to do only with electromagnetic energy in the near field.

In Schantz (column 3, line 12), “In one embodiment, the comparison between two or more signal characteristics is the difference between E field phase and H field phase. In an alternate embodiment, the comparison is the difference between E field magnitude and H field magnitude. It is a feature of the invention that the E field and H field signal characteristic differences are particularly useful in the near field.” In all other Schantz embodiments, calibration data sets are used to determine range, not direction.

All of the above comparisons have no relevance in the far field. Schantz even states: “In the far field, at distances greater than one wavelength, both the electric and magnetic fields are phase synchronous. The phase of each field varies in lock step with the other field.” Thus, it would not be obvious to those skilled in the arts of direction finding to use such structures to determine either direction or range to a transmitter in the far field. According to Schantz, they work only “to a range of about 0.30, from the beacon”. They predominantly work by determining range (column 18, line 9) based on the phase difference between the E and H fields in the near field. They do not determine direction. The structures in Schantz are designed to be omnidirectional (column 17, line 45), having no sensitivity of any kind to the direction from which the received electromagnetic energy comes from. According to Schantz (column 32, line 59), “About a small electric antenna (small relative to ¼ wavelength), for instance, the phase delta varies with range, but does not vary with respect to angle, such as azimuth angle”. Thus, it would not be obvious to those skilled in the arts of direction finding to use such structures to determine direction at all.

The present invention is different from prior art in that it uses direct phase comparison and it:
eliminates the use of summing or differencing circuits between the antennas;
eliminates the use of the directional/gain characteristics of the loop antennas;
eliminates the requirements that the antennas be orthogonal to each other;
eliminates the requirements that the antennas are electrically coupled;
make use of a wider range of loop antennas, from electrically small to medium sized antennas;
has the same or better performance characteristics as most summing or differencing systems;
simplifies the circuits and calculations;
is not sensitive to varying signal strength when compared to systems that uses signal strength;
increases the sensitivity and accuracy over implementations using small loop or magnetic antennas; and
provides for a reduction in size compared to some other techniques.

The present disclosure applies to the field of direction finding in the far field and teaches the use of direct phase measurements to determine direction to a source emitting electromagnetic energy. The phase comparisons performed are not between the electric (E) and magnetic (H) fields, which are in lock step in the far field. Rather, the phase comparisons performed are between specially designed and specially disposed antennas. One embodiment, uses loop antennas designed to have an omnidirectional amplitude response, but a directional phase response. Other embodiments use loop antennas designed to have directional responses in both amplitude and phase. The loop antennas are disposed to give good directional phase sensitivity while still being compact.

The present disclosure is directed generally to a direction-finding receiver that determines the originating direction of the received radio-signal, without ambiguity, at a distance of approximately one to multiple wavelengths of the radio signal using two loop antennas and a reference antenna and a direct phase comparison technique. The direction of the originating radio signal can be determined automatically without the having to rotate the apparatus or moving or rotating one or more antennas. A direct phase comparison technique is defined as finding the phase difference between two of the antenna signals, typically after down conversion, with a phase comparator, also known as a multiplier. By comparing the phase difference between the two loop antennas and the reference antenna, the direction of the incoming signal can be determined without ambiguity. In addition, a method is shown where a bearing angle signal can be generated that is twice as sensitive as the signal generated from a loop antenna and the reference antenna by comparing the phase difference between two loop antennas and by inverting the output of one antenna relative to the other. Inverting one of the loop antenna output relative to the other can be achieved by one of three methods: 1) by reversing the winding direction of one loop antenna relative to the other, 2) by reversing the input and output terminals of the loop antennas relative to each other or 3) by inverting the signal from one of the loop antenna relative to the other given that the windings of each loop antenna are in the same plane and the winding plane of one antenna relative to the winding plane of the other antenna is within +/−90 degrees.

Other simpler embodiments in the present disclosure utilize only a single loop and reference antenna while utilizing the direct phase comparison technique. In these embodiments, ambiguity is present so the originating direction of the radio signal can be determined by rotating the apparatus.

The loop antennas themselves create the phase shift in the output signal by measuring the ratio of the electric to magnetic field amplitude responses as in a medium loop antenna or by the fact that the magnetic fields enter from one side or the other side of the loop antennas. Unlike prior art, the loop antenna in the present disclosure is not limited to small loops or magnetic antennas but allows for electrically responsive loop antennas as well, such as in medium loop antennas.

The present disclosure utilizes the higher sensitivity of medium loop antennas and their sensitivity to the electric field to increase the range and to generate a smoother bearing angle signal, allowing for greater resolution over a system using small loop antennas.

There are significant differences with systems that sum verses ones that multiply. When summing and/or differencing two signals, the resultant signal depends on the amplitude of the individual signals. Most loop antennas do not have a uniform field strength response so a system using summing/differencing utilize this unique characteristic of the antenna beam pattern. Typically two orthogonal small loop or magnetic antennas are used so that the null of one of the antennas is at the maximum sensitivity of the other. Phase comparison systems do not use the signal amplitude and are not sensitive to antenna beam pattern, except for the loss of signal at the null. Thus a system using summing/differencing would have completely different architecture, operate on different principles, have different electronics and would require different algorithms.

The proper utilization of a direct phase comparison technique requires an understanding of the phase characteristics of loop antennas with respect to their electrical size and the direction of the winding. Characterization of the phase response of loop antennas has not been found in prior art and is developed and shown in the present disclosure to show how an apparatus may use the direct phase comparison instead of the summing/differencing technique.

### BRIEF DESCRIPTION OF THE DRAWINGS

FIG. 1A depicts a small-loop antenna, and shows that as the H̅ field (magnetic field) enters from one side ( H̅1) the current flows in one direction (Ī1) and when the H̅ field enters from the opposite direction ( H̅2) the current phase ( H̅2) reverses.

FIG. 1B depicts a small-loop antenna, when viewed from the top, with the loop windings in the y-z plane. The angle α, which is defined as the angle in the x-y plane from the x axis to the winding plane of the loop antenna, is 90 degrees. The incoming RF signal is from the top of the page (along the y axis).

FIG. 1C depicts the phase output of a small-loop when rotated with angle α from 0 to 360 degrees. The phase output is constant when α is greater than 0 and less than 180 degrees. The phase output from the antenna will flip 180 degrees when the angle is greater than 180 degrees and less than 360 degrees. The phase shift is sharp for a small-loop antenna since the magnetic field enters the antenna from either one side or the other and its response to the electric field is minimal. The phase response of a small-loop antenna is either 0 or 180 degrees.

FIG. 1D depicts a typical profile of a small-loop antenna amplitude response, also known as a gain or beam pattern response.

FIG. 2A depicts the typical characteristics for a large, one-wavelength, loop antenna. The large-loop antenna response (that is, the current Ī1) is primarily to the electric field Ē.

FIG. 2B depicts a large-loop antenna, when viewed from the top, with the loop windings in the y-z plane so that angle α (defined in FIG. 1) is 90 degrees and the incoming RF signal from the top of the page (along the y axis).

FIG. 2C depicts the phase output when the large, one-wavelength, loop antenna in FIG. 2A is rotated relative to the incoming RF signal. When α varies from 0 to 360 degrees, the phase output of the antenna is a constant since a large loop antenna responds purely to the electric field.

FIG. 2D depicts a typical profile of the antenna-gain or beam pattern amplitude response of a large, one-wavelength, loop antenna.

FIG. 3 is a graph of the phase response for both a small-loop antenna and for medium-loop antennas where the small loop antenna is represented by the curve “1” and the medium loop antennas by the curves “0.85” and “0.7”.

FIG. 4 depicts one embodiment of a circuit block diagram for a system using one single-loop antenna and one reference antenna.

FIG. 5 depicts one embodiment of the antenna arrangement for a three-antenna system, shown from a top-view perspective. The three antennas are oriented with the winding planes of the loop antennas and the axis of the reference antenna perpendicular to the x-y plane, while the transmitter is situated in the x-y plane. The apparatus determines the direction of the incoming RF in the x-y plane.

FIG. 6 depicts one embodiment of a circuit block diagram for a system using three antennas.

FIG. 7 depicts an alternative embodiment of a circuit block diagram for a system using three antennas.

FIG. 8 is a graph depicting the phase-detector outputs versus incident RF angle for a three-antenna system that uses two medium-loop antennas, with one loop antenna output inverted with respect to the other loop antenna.

FIG. 9 is a graph depicting the phase-detector outputs versus incident RF angle for a three-antenna system that uses two medium-loop antennas, not having the output of one loop inverted with respect to the output of the other loop antenna.

FIG. 10A is a graph depicting the phase-detector output of the phase difference between two small-loop antennas, L2 and L1, using the formula L2*(L1+90 degrees), and with one loop antenna output inverted with respect to the other loop antenna.

FIG. 10B is a graph depicting the phase-detector output, L1*(D+90 degrees), of the phase difference between the small-loop antenna L1 and the reference antenna D,

FIG. 10C is a graph depicting the phase-detector output, D*(L2+90 degrees), of the phase difference between the small-loop antenna L2 and the reference antenna D.

FIG. 10D is a graph combining FIGS. 10A, 10B and 10C.

FIGS. 11A-11C show three methods to invert the loop antenna signal of one loop antenna relative to another with the restriction that the planes which the loop antennas are wound are within +/−90 degrees of each other.

FIG. 11A is one method, showing the loop antennas with the outputs reversed from each other.

FIG. 11B is a drawing showing the loop antennas with winding directions reversed from each other to create the same effect as reversing the outputs from each other. If the reference terminal is taken as A, then one loop is wound clock wise while the other as counter clock wise when viewed from the same direction, perpendicular to the winding plane.

FIG. 11C is a drawing showing one of the loop antenna's amplifier outputs being inverted relative to each other.

FIG. 12A depicts a medium loop antenna. The medium-loop antenna response is both to the electric field Ē and the magnetic field H̅.

FIG. 12B depicts a medium-loop antenna, when viewed from the top, with the loop windings in the y-z plane so that angle α (defined in FIG. 1) is 90 degrees and the incoming RF signal from the top of the page (along the y axis).

FIG. 12C depicts the phase output when the medium-loop antenna in FIG. 12B is rotated relative to the incoming RF signal with angle α from 0 to 360 degrees. The phase output is smoother compared to the abrupt change in a small loop antenna.

FIG. 12D depicts a typical profile of the antenna-gain or beam pattern amplitude response of a medium-loop antenna. Because a medium loop antenna responds to both the electric and magnetic field, the bean pattern is a combination of the beam pattern of a small and a large loop antenna.

### DETAILED DESCRIPTION

### Overview

The present disclosure is directed generally to a direction-finding receiver that determines the originating direction of the received radio-signal source at near and long ranges, from approximately one to multiple wavelengths distance. In typical embodiments, one or two loop antennas are employed in combination with a reference antenna (typically a dipole antenna), and a direct-phase comparison of the signal from the antennas is performed, which is significantly unlike the existing art.

Although the existing art uses two loop antennas and a reference antenna, the way the existing art uses the antennas to determine the direction of the signal are significantly different than what is discussed in this disclosure. Generally speaking, existing systems in the art make use of the summing and/or difference of the loop antenna signal in the determination of the incident RF angle. It requires that the loop antenna have an amplitude component that is dependent on angle of the incident RF signal so that the summation of the loop antenna's signal with the reference antenna's signal will create a composite signal that has a composite amplitude and a composite phase of the two antennas. It also requires that the phase of each of the loop antennas remains relatively constant but different than the phase of the other loop antenna over a defined incident angle or rotation. Typically, this limits the design to small loop or magnetic antennas with a preference that the antennas be near each other.

The difference between the new systems described in this disclosure and the existing art for dual-loop antennas is that the new systems described herein do not use the summing and difference of the RF signal, but instead use a direct-phase comparison technique. Direct-phase comparison is defined as comparing directly the phase difference between two signals, done with a mixer which multiplies the two signals together. Direct-phase comparison requires that the phase of each of the antennas changes, either abruptly or continuously, relative to the phase of the other antenna when the incident RF angle changes. The new systems presented herein allow the use of both small-loop and medium-loop antennas, thus allowing greater design flexibility. In the direct-phase comparison technique, the antennas are not required to have a specific gain pattern.

Often, existing systems in the art require that the loop antennas be orthogonal to each other. The new systems described in this disclosure allow the antennas to be at almost any angle to each other, which once again facilitates greater design flexibility and allows for more-compact physical configurations. Because the loop antenna-gain pattern is not an issue in the present disclosure, the new systems presented herein allow for the use of one or more medium-loop antennas, discussed infra. Generally speaking, a medium-loop antenna has better sensitivity to the RF signal than a small-loop antenna, which in turn allows for a greater signal-receiving range.

Moreover, a medium-loop phase response is not sharp like that associated with a small-loop antenna (with the phase response being zero or 180 degrees). In addition, unlike a one-wavelength, large-loop antenna (which has little or no phase response), the medium-loop phase response is soft and varies based on the incident RF angle. Several embodiments of the new systems described herein take advantage of the medium-loop-antenna characteristics in order to more-effectively determine the incident RF signal direction.

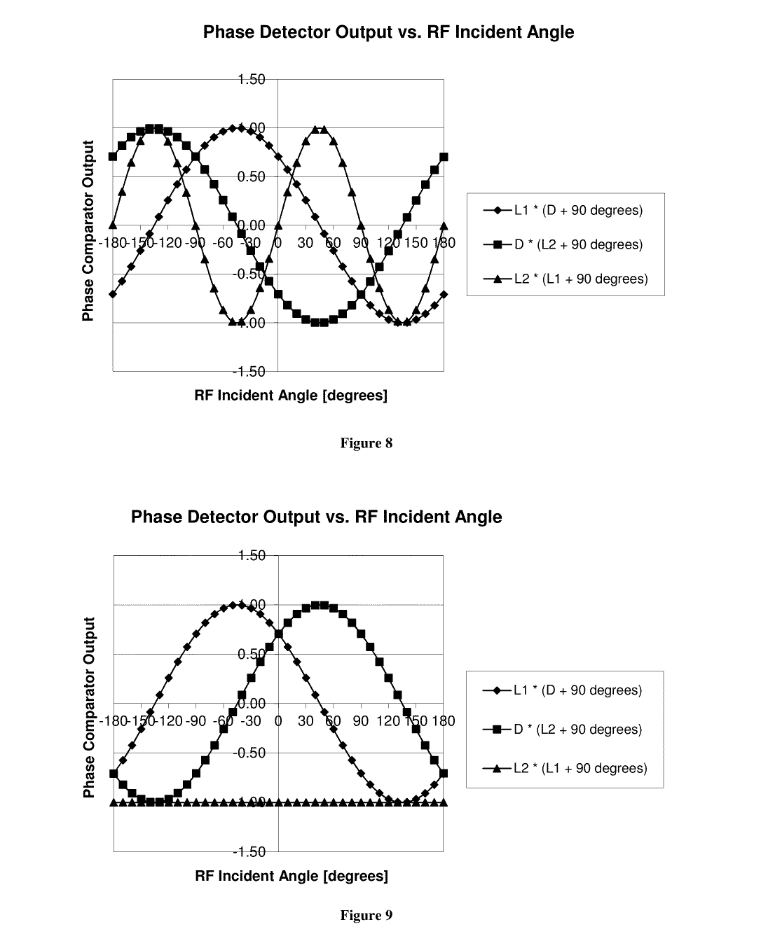

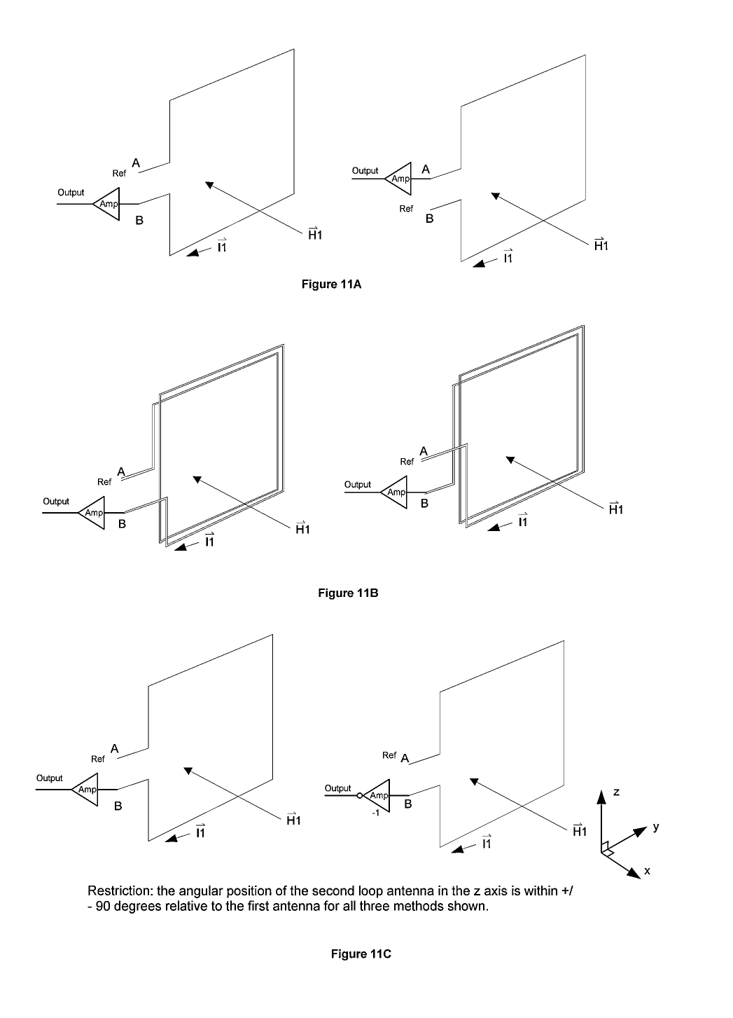

Another distinction and advantage with the new systems described herein, is that if one of the two loop antennas output is inverted from the other using one of the methods shown in FIGS. 11A-11C, a third bearing angle signal between the two loop antenna can be developed which changes at twice the rate of the incident RF angle. FIG. 8 shows that the bearing angle signal generated when the output of loop antenna 1 with a 90 degree phase shift is multiplied with loop antenna 2, as define by the equation L2*(L1+90 degrees) changes at twice the rates as the outputs of loop antenna 2 or loop antenna 1 is multiplied with the reference antenna D as defined by the equation D*(L2+90 degrees) or L1*(D+90 degrees). The resultant double-frequency output can be used to get a more accurate directional accuracy.

Some of the embodiments of the new systems described herein can use only two antennas, a single loop antenna, small or medium in electrical size, and a reference antenna, yet still be effective. Although such a system of a single loop and a reference antenna will not allow the system to directly calculate the direction of the incident RF angle, the user is still able to determine exactly the direction of the RF signal by rotating the portable apparatus according to the right/left direction indicator on the apparatus. The advantage of using only a single loop antenna and a reference antenna is that it can be made smaller and simpler than a dual loop antenna with a reference antenna.

The embodiments of the apparatus described herein can be configured for fixed-mounted configurations, as well as portable configurations. In fixed mounted applications and embodiments where it is necessary for the apparatus to be rotated to determine the direction of the RF signal source, the apparatus can be fixed-mounted on a rotatable platform so that the apparatus can be rotated. Rotating the apparatus for such fixed-mounted configurations is the equivalent to rotating the apparatus in the portable configurations.

### Terminology

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least one embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, “left”, “right”, “nadir”, “apex”, “top”, “bottom”, “vertical”, “horizontal”, “back”, “front”, and “lateral” are relative to each other, are dependent on the specific orientation of an applicable element or article, are used accordingly to aid in the description of the various embodiments, and are not necessarily intended to be construed as limiting.

As applicable, the terms “about” or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “small-loop antenna” or a loop antenna having an “electrical size of a small-loop antenna”, as used in this specification and the appended claims, refers generally to an antenna consisting of a “loop” of wire or other conductor (though the shape of the loop need not be round or circular), with its ends connected to a two-wire transmission line for signal transmission. Generally speaking, the size of a “small-loop antenna” has a maximum length of the “loop” of the antenna (that is, the total length of the conductor in the loop) of 0.25λ (wavelength), though most “small-loop” directional-receiving antennas have a maximum length of 0.1λ. For the purposes of this patent application, a “small-loop antenna” has a maximum length of 0.1λ. The primary characteristic when used in this patent is that a “small-loop antenna” responds primarily to magnetic fields, and almost not at all to electric fields. A small loop antenna is a magnetic antenna. A loop antenna can be also be made magnetic and respond only to the magnetic field through the method of shielding.

The term “large-loop antenna” or a loop antenna having an “electrical size of a large-loop antenna”, as used in this specification and the appended claims, refers generally to an antenna consisting of a “loop” of wire or other conductor (though the shape of the loop need not be round or circular), with its ends connected to a two-wire transmission line for signal transmission. The size of a “large-loop antenna” has a total length of the “loop” of the antenna (that is, the total length of the conductor in the loop) of at least 1λ (wavelength). A “large-loop antenna” responds primarily to electric fields, and almost not at all to magnetic fields. A “large-loop antenna” generally exhibits a higher gain than a “small-loop antenna” or a “medium-loop antenna”, as the gain of this type of antenna is directly proportional to the area enclosed by the loop. “Large-loop antennas” usually have their strongest signal response with the electric field within the plane of the loop, and the nulls are with the electric field in the axis perpendicular to the plane of the loop.

The term “medium-loop antenna” or a loop antenna having an “electrical size of a medium-loop antenna”, as used in this specification and the appended claims, refers generally to an antenna consisting of a “loop” of wire or other conductor (though the shape of the loop need be round or circular), with its ends connected to a two-wire transmission line for signal transmission. The electrical size of a “medium-loop antenna” falls between that of a “small-loop antenna” and a “large-loop antenna”, and as a result is responsive to both magnetic and electric fields. “Medium-loop antennas” are adapted to generate a phase response to received electric and magnetic waves to approximate a sine wave, or at least exhibit a gradual phase change.

The term “windings”, as used in conjunction with loop antennas within this specification and the appended claims, refers to additional turns of antenna conductor that are employed to increase the gain and/or effective aperture of a given loop antenna, which generally enhances the effectiveness of a loop antenna that is used in a radio-signal directional finding application.

The term “moved” or “rotated”, as used in reference to manipulating the position of a radio-signal-source direction-finding receiver apparatus within this specification and the appended claims, refers to the rotation of the apparatus along a horizontal plane and/or the rotation of the apparatus along the vertical plane or pitch in order to optimize radio-signal source direction detection.

The term “bearing angle signal”, or similar terms, as used within this specification and the appended claims, refers to the phase difference calculation between the different antennas that comprise a radio-signal-source direction-finding receiver. As used in this patent application, the bearing angle signal is generated from the loop antenna multiplied with the reference antenna or between the two loop antennas after down conversion. A bearing angle signal may also be calculated by a microprocessor from the two bearing angle signals of the apparatus. This microprocessor generated bearing angle signal is a calculation and not a physical output of a multiplier. The bearing angle signals provides bearing information, though the bearing signal may or may not be “unified” as explained in the next paragraph.

The term “unified bearing angle signal”, or similar terms, as used within this specification and the appended claims, refers to the use of all of the bearing angle signals generated by the system to determine the originating direction of a detected radio signal without ambiguity.

The term “ambiguity”, as used within this specification and the appended claims, when referred to directionality, is a condition where there is more than one location where the signal is identical. Ambiguousness can occur whether the signal is 180 degrees from each other or smaller angles. For example, a loop antenna gives ambiguous direction that is 180 degrees from each other. Although a Yagi antenna has one direction where the signal strength is at a maximum, there are two symmetrical points on either side of the maximum where the received signal strength is the same. So based on a single antenna measurement, not at the maximum, and without additional measurements, it is not possible to determine which one of the two equal identical signal strength points were measured.

### Detailed Discussion of the Phase Characteristics of Small-Loop, Medium-Loop, and Large-Loop Antennas

Loop antennas are often categorized by the total length of the conductor in the loop. A small-loop antenna, typically defined as having the total loop conductor length of less than or equal to 0.1λ (wavelength), responds primarily to the magnetic field. In comparison, a large-loop antenna, with the total loop conductor length of about 1λ, responds primarily to the electric field.

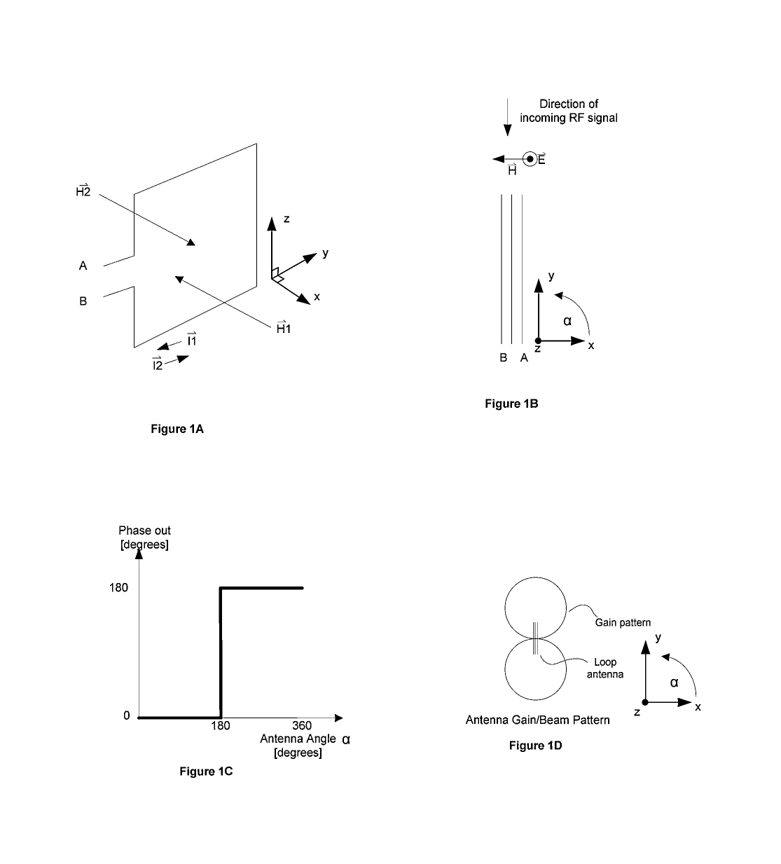

Refer to FIGS. 1A-1D, which combine to show the typical characteristics for a small-loop antenna. FIG. 1A shows that as the magnetic field (generically referred to as H̅) enters from a first side H̅1, the current flows in one direction Ī1, and when the magnetic field enters from a second side H̅2, the resultant current flows in the opposite direction Ī2. FIG. 1B depicts the top view of the small-loop antenna, with the antenna rotated by angle α, relative to a horizontal axis. FIG. 1C shows the phase response of the small-loop antenna when the small-loop antenna is rotated relative to the incoming RF signal. Given that the RF signal is coming from the top of the page and α is the angle of the antenna relative to the horizontal axis as shown in the drawings, the phase response is constant when α is greater than 0 and less than 180 degrees. The phase from the antenna will flip 180 degrees when the angle is greater than 180 degrees and less than 360 degrees. The phase shift is sharp for a small-loop antenna since the magnetic field enters the antenna from either one side or the other and its response to the electric field is minimal. Hence, the phase response of a small-loop antenna is either 0 or 180 degrees. Finally, FIG. 1D shows the plot of a typical small-loop antenna gain response.

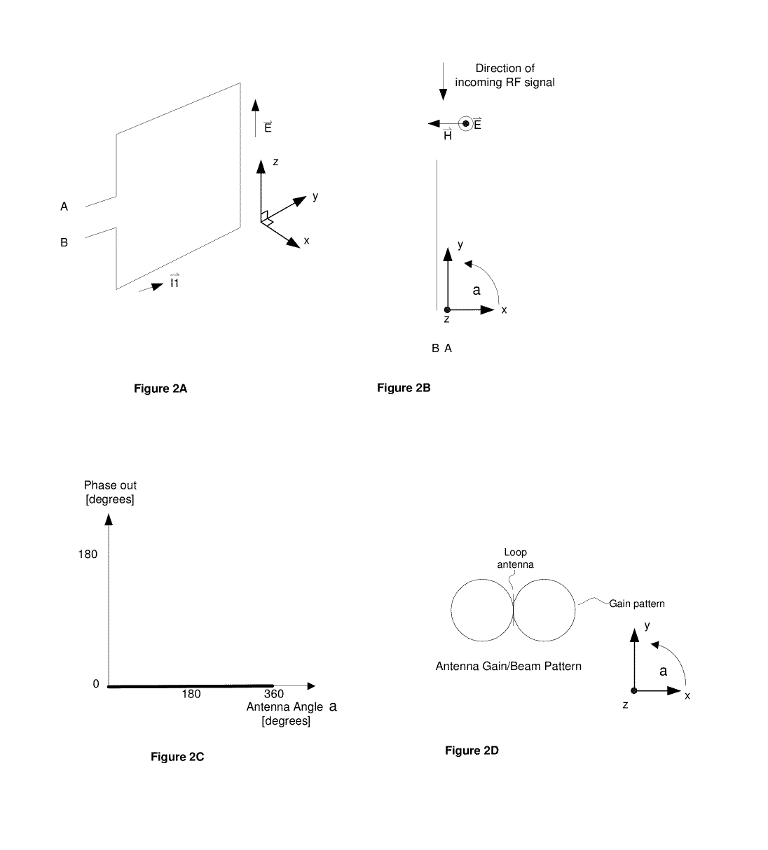

Refer to FIGS. 2A-2D, which combine to show the typical characteristics for a large-loop, one-wavelength (1λ) antenna. FIG. 2A shows that the antenna response is due primarily to the electric field E. The large-loop antenna phase response does not change when the antenna is rotated relative to the incoming RF signal; therefore, when α varies from 0 to 360 degrees, the phase of the antenna is a constant, as shown in FIGS. 2B and 2C. Finally, FIG. 2D shows the antenna gain response plot of a typical large-loop antenna. Note that the gain response of the large-loop antenna is rotated 90 degrees from the gain response of the small-loop antenna.

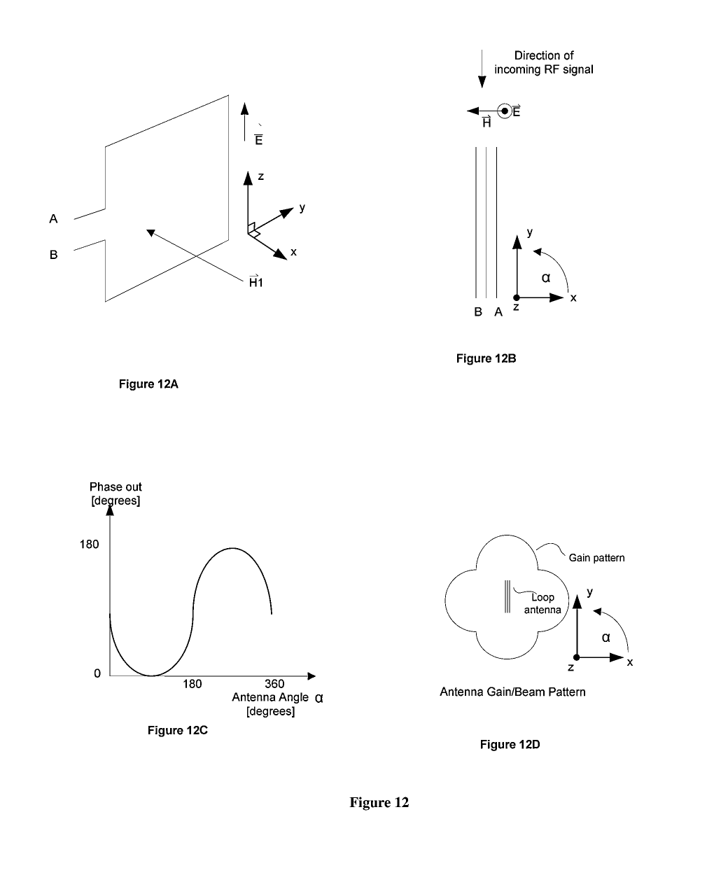

Refer to FIGS. 12A-12D, which combine to show the typical characteristics for a medium-loop antenna. FIG. 2A shows that the antenna response is due to both the electric field Ē and the magnetic field H̅. Instead of having an abrupt phase change, as in the case of a small-loop antenna, or no phase change, as in the case of a large-loop antenna, the medium-loop antenna's gradual phase change, FIG. 12C, can be used to increase the resolution in determining the direction of the received RF signal. Finally, FIG. 12D is an example of the antenna gain response plot of a medium-loop antenna. Note that the gain response of the medium-loop antenna is a combination of a small loop and large loop antenna responses. The exact phase and gain response of a medium loop antenna will depend on the ratio of the magnetic vs. electric field response.

To create a medium-loop antenna, the total conductor length is increased from a small-loop antenna until the desired response is obtained. The number of turns, the gap between the turns, and the size of the loop will also affect the characteristic of the resultant medium-loop antenna. The ratio of the antenna's magnetic-field response and electric-field response determines the phase response of the overall antenna that incorporates at least one medium-loop antenna.

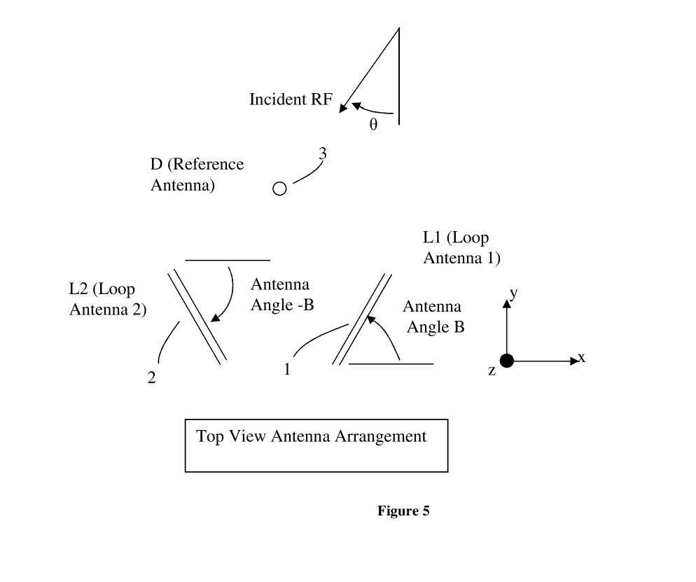

The equations for the response of loop antennas are developed based on the antenna layout shown in FIG. 5. FIG. 5 shows a three antenna system with two loop antennas, L1 and L2 and a reference antenna D, θ is the incident RF relative to the −y axis. If B is taken to be zero so the loop antenna windings are in the x-z plane, the characteristic response of a small-loop antenna can be approximated by the formulas:

|sin θ|sin(ωt),0°<θ<180° (Formula 1)

−|sin θ|sin(ωt),180°<θ<360° (Formula 2)
where:
   θ is the RF incident angle on the antenna
   ω is the signal/driving frequency
   t is time in seconds

The characteristic response of a one-wavelength (1λ), large-loop antenna can be approximated by the formula:

|cos θ|cos(ωt),for all θ (Formula 3)
where:
   θ is the RF incident angle on the antenna
   ω is the signal/driving frequency
   t is time in seconds

However, the characteristic response of a medium-loop antenna can be approximated as the summation of the large-loop and small-loop antenna responses, approximated by the formulas:

|A sin θ|sin(ωt)+|(1−A)cos θ|cos(ωt),0°<θ<180°,0≦A≦1 (Formula 4)

−|A sin θ|sin(ωt)+|(1−A)cos θ|cos(ωt),180°<θ<360°,0≦A≦1 (Formula 5)
where:
   A is a factor that describes the medium-loop antenna response to the magnetic field versus the electric field
   θ is the RF incident angle on the antenna
   ω is the signal/driving frequency
   t is time in seconds

Using trigonometric identities, the formula for the medium-loop antenna above can be represented by the following formulas:

$$\begin{matrix}( \sqrt{{( A sin θ )}^{2} + {( 1 - A )}^{2} {cos}^{2} θ } ) ( sin ( ω t + ϕ ) ) & ( Formula 6 ) \\ ϕ = {sin}^{- 1} ( \frac{\vert ( 1 - A ) cos θ \vert}{\sqrt{{( A sin θ )}^{2} + {( 1 - A )}^{2} {cos}^{2} θ }} ) , \\ 0 ° < θ < 180 ° & ( Formula 7 ) \\ ϕ = π - {sin}^{- 1} ( \frac{\vert ( 1 - A ) cos θ \vert}{\sqrt{{( A sin θ )}^{2} + {( 1 - A )}^{2} {cos}^{2} θ }} ) , 180 ° < θ < 360 ° & ( Formula 8 )\end{matrix}$$

where:
   A is a factor that describes the medium-loop antenna response to the magnetic field versus the electric field
   θ is the RF incident angle on the antenna
   ω is the signal/driving frequency
   φ is the phase response of the medium loop antenna
   t is time in seconds

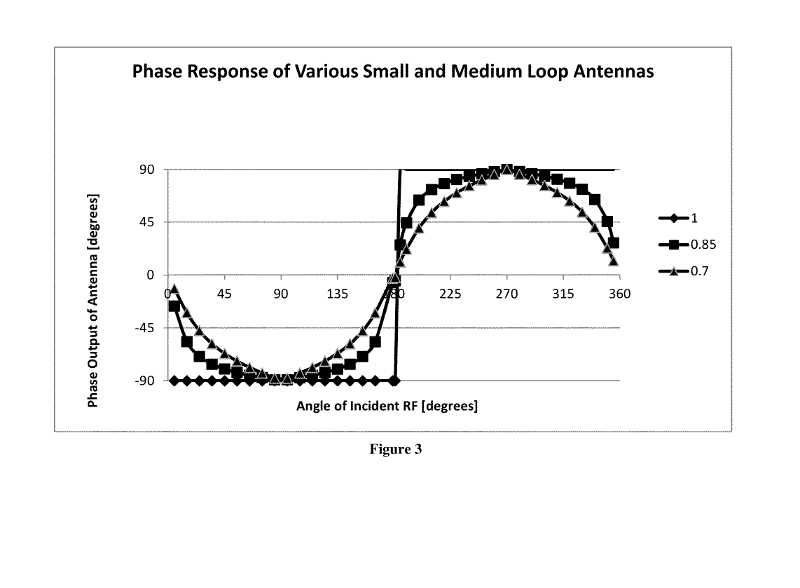

An A of 1 means that the antenna acts like a small-loop antenna and responds only to the magnetic component of the incident RF field, and an A of 0 means the antenna responds like a 1-wavelength, large-loop antenna. FIG. 3 shows the relative phase response of the loop antenna for a few values of A: 1, 0.85, and 0.7. An A of 0.85 means that 85 percent of the signal is in response to the magnetic field and that 15 percent of the signal is in response to the electric field. The phase response can be adjusted to be approximately that of a sine wave, sharper or less sharp, depending on the need.

Another advantage of incorporating a medium-loop antenna in a direction-finding receiver is that the amplitude null typically found in the small-loop antenna is reduced. Consequently, there is not a loss of signal at the null for medium-loop antennas. A loss or reduction in the signal strength at the nulls can significantly reduce the sensitivity, resulting in a loss in range. Thus in many applications it is more desirable to use a medium loop antenna over a small loop antenna.

The amplitude response of a medium-loop antenna is represented by the expression \sqrt{(A sin θ)²+(1−A)² cos² θ} of the Formula 6, supra.

### First Embodiment

### A Dual-Antenna RF-Direction-Finding Receiver

This embodiment is directed generally to a direction-finding receiver that determines the originating direction of the received radio-signal source, which in some variations is adapted to be readily portable. In typical examples, a single loop antenna is employed in combination with a reference antenna (typically a dipole antenna), and a direct-phase comparison of the signal from the antennas is performed.

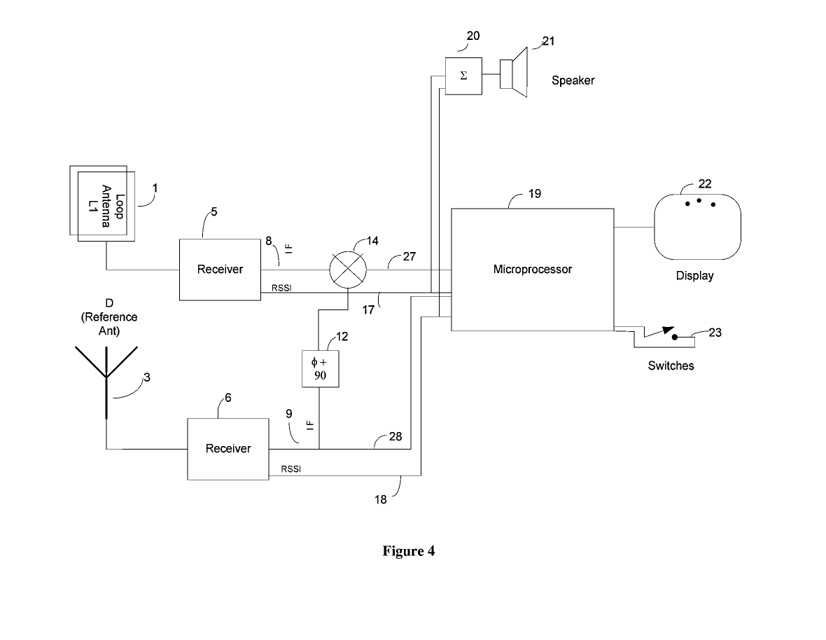

Refer to FIG. 4, which depicts a basic circuit block diagram for one embodiment for such dual-antenna design. In many variations, the phase characteristics of a small-loop antenna or medium-loop antenna 1 is used in conjunction with a reference antenna 3 in order to determine the originating direction of a received RF signal. The loop antenna phase signal 8 is compared with the reference antenna phase signal 9. The phase output of the apparatus in FIG. 4 is the same as that shown in FIG. 3. When the phase is greater than zero, the directional indicator display 22 will prompt the user to rotate the device in a first direction. Conversely, when the phase is less than zero, the directional indicator display 22 will prompt the user to rotate the device in the opposite direction. The right or left directional indicator on the display 22 is determined by the phase output from the microprocessor 19.

There are two zero-phase cross-over points for the device depicted in the example in FIG. 4: One is directly in front of the apparatus, defined here as zero degrees (or as the “zero-degree position”), and the second zero-phase cross-over point is located at the opposite direction of the signal, defined here as 180 degrees (or as the “180-degree position”). When the user is pointing the apparatus represented in FIG. 4 in the exact opposite direction (180 degrees) and rotates the apparatus slightly to the right or left, the directional indicator display 22 will indicate a direction away from the 180-degree position. Accordingly, the user will know that the direction is correct when the user rotates to the right or left, causing the right and left indicators on the display 22 to point the user back to the center (as opposed to away).

The two radio signal strength indicators (RSSIs) 17, 18 from the receivers 5, 6, respectively, are fed into and digitized by the microprocessor. The signal strength is put on the display 22 where a user can use the signal strength to estimate the distance of the receiver to the source.

In some configurations, by using the antenna-gain characteristics of the loop antenna 1, or by using the gain characteristic of the reference antenna 3 when it interacts with the loop antenna 1, or by using the gain characteristic of the loop antenna 1 when it interacts with the reference antenna 3, a user can use the signal strength indicator 22 as an additional source of information to determine the RF source direction and distance to the RF source as the apparatus position is changed. The microprocessor 19 may also use the antenna-gain characteristic to improve the accuracy of the directional indicator display 22.

In applications when the RF signal is amplitude-modulated with an audio signal, the receivers' 5, 6 radio-signal strength indicator signals 17, 18 are demodulated and amplified with an audio amplifier 20. The audio signal is then used to modulate speaker 21 in order to give a user an audio indication of the RF signal.

In some variations, the RSSI signals 17, 18 are fed and summed in an audio amplifier 20 and then to a speaker 21, in order to give a user an audio indication as to the RF source direction as the apparatus position is changed.

Even though this embodiment uses only two antennas (a single loop antenna 1 (small or medium in electrical size) and a reference antenna 3), it can yet still be effective. Generally, such a system using only a single loop and a reference antenna will not allow the system to directly calculate the direction of the incident RF angle; however, the user is still able to determine exactly the direction of the RF signal by rotating the apparatus according to the right/left direction indicator on the apparatus. A system can be developed where a motor can automatically rotate the apparatus based on the bearing angle signal to determine the direction of the incoming signal. The advantage of using only a single loop antenna and a reference antenna is that it can be made smaller and simpler than a three-antenna system that has two loop antennas and a reference antenna.

### Second Embodiment

### A Three-Antenna RF-Direction-Finding Receiver

This embodiment is directed generally to a direction-finding receiver that determines the originating direction of the received radio-signal source, which in some variations is adapted to be readily portable. In typical examples, two medium-loop antennas are employed in combination with a reference antenna (typically a dipole antenna), and a direct-phase comparison of the signal from the antennas is performed.

In many variations, the phase characteristics of two medium-loop antennas are used in conjunction with a reference antenna in order to determine the originating direction of a received RF signal. The full implementation employs two medium-loop antennas and a reference antenna, as shown in FIG. 5, from a top-view perspective. The three antennas (a first loop antenna (L1) 1, a second loop antenna (L2) 2, and a dipole reference antenna (D) 3 are arranged with a distance between them much less than one wavelength (1×). L2 2 has its output inverted as compared to L1 1 using one of the methods shown in FIGS. 11A-11C: 1) by reversing the winding direction of one loop antenna relative to the other, 2) by reversing the input and output terminals of the loop antennas relative to each other or 3) by inverting the signal of the second loop antenna relative to the first, given that the planes in which the loop antenna are wound are within +/−90 degrees of each other. When the second antenna is at an angle greater than +/−90 degrees relative to the first antenna, the result is the same as inverting the output of the second antenna relative to the first but defining the second antenna as being at an angle of (180) minus (the absolute value of the antenna angle relative to the first antenna). For example, if the second loop antenna is rotated 100 degrees from the first, it is the same as the second loop antenna being 80 degrees rotated from the first with the output of the second loop antenna inverted relative to the first. For the purposes of this document the second loop antenna is restricted to being positioned at an angle less than +/−90 degrees relative to the first antenna and the loop winding planes are orthogonal to the x-y plane.

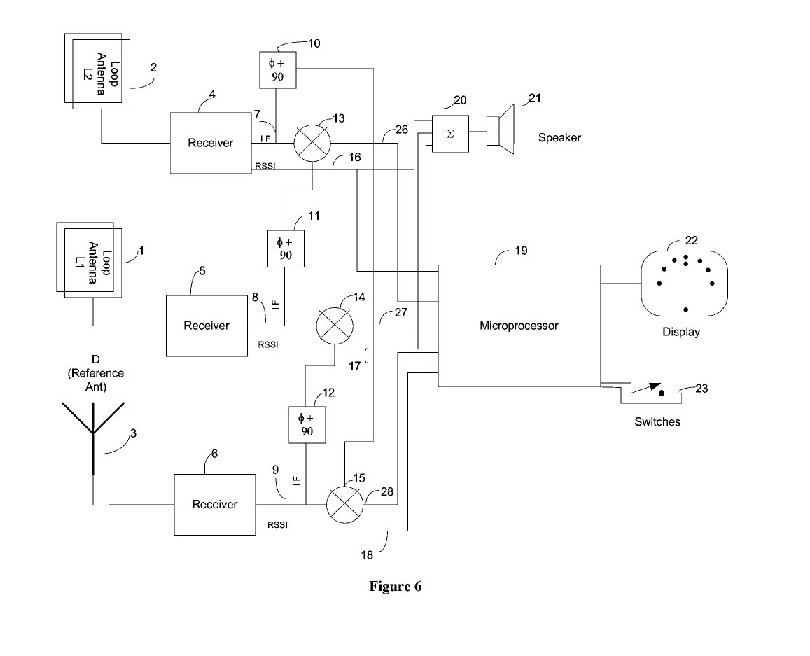

D 3, the reference antenna, has phase response that does not change relative to direction of the incoming RF signal. In variations of this embodiment, the reference antenna 3, can be a dipole type, a monopole type, a helical type, or any other type of antenna to be effective. The winding planes of L1 1 and L2 2 are perpendicular to the x-y axis, and if a dipole or similar antenna is used for D 3, then D 3 would be oriented in the z-axis and also be perpendicular to the x-y axis as shown in FIG. 5. Moreover, the two loop antennas 1, 2 are typically placed at equal, but opposite, angles relative to the reference antenna 3, though this is not necessarily a requirement as long as the loop antennas 1, 2 are not parallel to each other and within +/−90 degrees relative to each other. If the distance between the antennas 1, 2, 3 is not short relative to the RF signal wavelength, then the phase will need to be adjusted due to the fact that RF signal will arrive at different times at the antennas depending on the direction of the incident RF signal. Similarly, an unsymmetrical antenna orientation would result in a phase comparator output (see FIG. 6; 13, 14, 15) that has a phase shift relative to the other antennas; however, such an offset can be compensated in a system that calculates the direction of the RF signal as well. A signal is coming to the three antennas along the x-y plane and its angle of arrival is defined as θ. For example, when θ is zero degrees the incoming RF is directly in front of the reference antenna, or similarly when θ is 30 degrees, the signal is coming in 30 degrees in a clockwise direction relative to the reference antenna.

The angle of the two loop antennas 1, 2, relative to the incoming RF signal, determines the phase of the outputs. By comparing the phase difference between the two loop antennas 1, 2 to the reference antenna 3, two vectors are generated that determine the direction of the transmitting signal without the 180-degree ambiguity that might be realized using existing-art systems. By comparing the phase difference between the two loop antennas 1, 2, to each other, a double-frequency phase response (FIG. 6; 26) is obtained which can be used to obtain more precise directional indication 22 (see FIG. 6; 22). With three antennas 1, 2, 3, it is possible to determine the precise direction of the incident RF signal with no directional ambiguity.

Assuming: (1) a symmetrical loop-antenna orientation angle relative to the x-axis as shown in FIG. 5, with L1 having the angle B and L2 at angle −B, (2) L2 2 output is inverted compared to L1 1 using one of the methods shown in FIGS. 11A-11C, and (3) θ is the angle of the incident RF, then the equations used to describe the orientations of the three antennas 1, 2, 3 are:

L1=sin(ωt+θ+B) (Formula 9)

L2=sin(ωt−(θ−B)) (Formula 10)

L3=sin(ωt) (Formula 11)
where:
   θ is the RF incident angle on the apparatus
   B is the angle of the given antenna relative to the x axis
   ω is the signal/driving frequency
   t is time in seconds

Formula 9 shows that as the phase of Antenna L1 increases by θ, the phase of the Antenna L2, as shown in Formula 10, decreases by θ or vice versa. This effect can be conceptualized as the phase outputs of the loop antennas rotating in the opposite direction on an x-y plot.

Using the trigonometric multiplication identity,

$$sin u sin v = \frac{1}{2} [ cos ( u - v ) - cos ( u + v ) ] ,$$

as a phase-difference calculation means or algorithm, the resulting phase comparator outputs (see FIG. 6; 13, 14, 15) are shown in Table 1 below. The second cosine term with 2ωt (in the fourth column) is filtered out in the circuit, so only the first term in the fourth column is relevant.

TABLE 1
Phase Comparator Output of a Three-Antenna System With Loop Antennas Outputs reversed or
Windings reversed from each other or Output Signals inverted from each other

| PHASE | u | v | sinusinv |
|---|---|---|---|
| L2*(L1 + 90°) comparator 13 | ωt + θ +B | ωt − (θ − B) + 90° | $= \frac{1}{2} [ cos ( 2 θ - 90 ° ) - cos ( 2 ω t - 2 B + 90 ° ) ]$ |
| L1*(D + 90°) comparator 14 | ωt − (θ − B) | ωt + 90° | $= \frac{1}{2} [ cos ( - θ + B - 90 ° ) - cos ( 2 ω t - θ + B + 90 ° ) ]$ |
| D*(L2 + 90°) comparator 15 | ωt | ωt + θ +B + 90° | $= \frac{1}{2} [ cos ( - θ - B - 90 ° ) - cos ( 2 ω t + θ + B + 90 ° ) ]$ |

Of particular note, the phase output L2*(L1+90 degrees) in TABLE 1, the two loop antennas output multiplied together, has a double-frequency response relative to the incident RF angle θ, as shown by the term

$$\frac{1}{2} [ cos ( 2 θ - 90 ° ) ] ,$$

where a one degree change in θ results in 2 degrees of change on the bearing angle signal. Whereas the phase response of either individual loops antenna multiplied by the reference antenna, L1*(D+90° or)D*(L2+90°, has a single frequency response to the incident RF angle θ,

$$\frac{1}{2} [ cos ( - θ + B - 90 ° ) ]$$

and

$$\frac{1}{2} [ cos ( - θ - B - 90 ° ) ]$$

respectively. The double frequency response is used to more accurately determine the direction of the incident RF signal, since it is twice as sensitive to angle changes as compared to the other two signals.

FIG. 8 plots the phase comparator outputs (FIGS. 6; 13, 14, and 15) with angle B in FIG. 5 being 45 degrees. The incident RF angle is easily determined by the relationship of the phase signals L1*(D+90 degrees) and D*(L2+90 degrees).

Referring to FIG. 6, which shows an embodiment of a block diagram of the electronics used to determine the direction of the incident RF, an RF receiver 4, 5, 6 and phase comparator 13, 14, 15 is used for each antenna. The receiver selectively receives on a predetermined frequency to match the transmitter frequency. The phase comparators 13, 14, compare the phase differences between the different antennas: L1*(D+90 degrees), which is the first generated bearing angle; D*(L2+90 degrees), which is the second generated bearing angle; and L2*(L1+90 degrees), which is the third generated bearing angle. Ninety-degree phase shifters 10, 11, 12 are used to center the range of phase comparison for phase detectors which work by multiplying the two inputs; however, such phase shifting is not necessarily required for all implementations in variations of this embodiment. A microprocessor 19 accepts the first of the generated bearing angle 27 and the second generated bearing angle 28 as inputs, and calculates the bearing angle signal which represents the direction of the incident RF and shows the direction on a display 22. The microprocessor improves the resolution of the calculation by incorporating the third generated bearing angle 26.

The three radio signal strength indicators (RSSIs) 16, 17, 18 are fed into and digitized by the microprocessor 19. The signal strength is put on the display 22 where a user can use the signal strength to estimate the distance of the receiver to the source.

In some configurations, by using the antenna-gain characteristics of one or both of the loop antennas 1, 2, or by using the gain characteristic of the reference antenna 3 when it interacts with one or both of the loop antennas 1, 2, or by using the gain characteristic of one or both of the loop antennas 1, 2 when they interact with each other or with the reference antenna 3, a user can use the signal strength indicator 22 as an additional source of information to determine the RF source direction and distance to the RF source as the apparatus position is changed. The microprocessor 19 may also use the antenna-gain characteristic to improve the accuracy of the directional indicator display 22.

In applications when the RF signal is amplitude modulated with an audio signal, the receivers' 4, 5, 6 radio-signal strength indicator signals (RSSIs) 16, 17, 18 are summed, demodulated, and amplified with an audio amplifier 20. The audio signal is then used to modulate speaker 21 in order to give the user an audio indication of the RF signal.

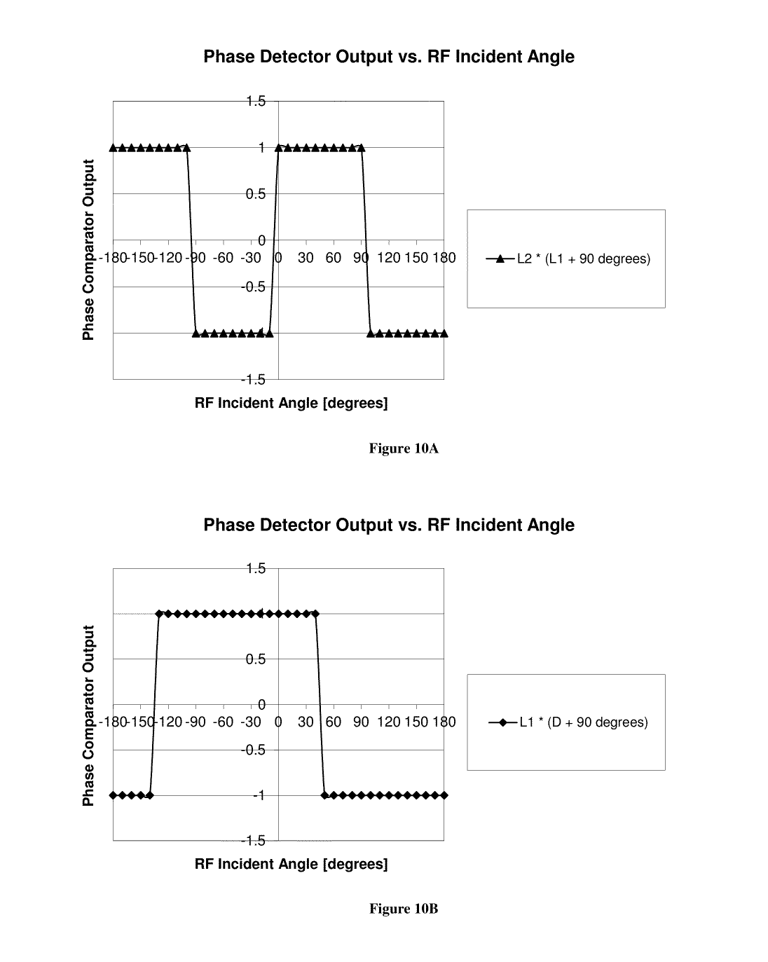

In an embodiment, if the windings of the second loop antenna (L2) 2 are not reversed relative to the windings of the first loop antenna (L1) 1 by using one the methods shown in FIGS. 11A-11C, then the phase difference between L1 and L2 becomes a constant as shown in FIG. 9 and, as a result, the double-frequency response relative to the incident RF angle, θ, is not present. Table 2 shows the resulting phase-comparator output equations for a system where L1 1 and L2 2 windings are not reversed from each other. The equation

$$\frac{1}{2} [ cos ( 2 B + 90 ° ) - cos ( 2 ω t + 2 B - 90 ° ) ] ,$$

shows that the first term is a constant and not dependent on the incoming RF angle θ. FIG. 9 graphically depicts a plot of the phase-comparator outputs for this system. Notice that the L2*(L1+90 degrees) curve is non-varying and provides no useful bearing information.

TABLE 2
Phase Comparator Output of a Three-Antenna System with Windings
of the Loop Antennas wound the same direction relative to each other and with Terminals
not inverted and Outputs not inverted

| PHASE | u | V | sinusinv |
|---|---|---|---|
| L2*(L1 + 90°) Comparator 13 | ωt + θ +B | ωt + θ − B + 90° | $= \frac{1}{2} [ cos ( 2 B + 90 ° ) - cos ( 2 ω t + 2 B - 90 ° ) ]$ |
| L1*(D + 90°) Comparator 14 | ωt + (θ − B) | ωt + 90° | $= \frac{1}{2} [ cos ( θ - B + 90 ° ) - cos ( 2 ω t + θ - B + 90 ° ) ]$ |
| D*(L2 + 90°) Comparator 15 | ωt | ωt + θ +B + 90° | $= \frac{1}{2} [ cos ( θ - B + 90 ° ) - cos ( 2 ω t + θ + B + 90 ° ) ]$ |

### Third Embodiment

### A Three-Antenna RF-Direction-Finding Receiver

This embodiment is directed generally to a direction-finding receiver that determines the originating direction of the received radio-signal source, which in some variations is adapted to be readily portable; however, unlike the Second Embodiment, described supra, the double-frequency phase response (and resultant increase in accuracy) is either not needed or is not generated in the circuit, or if needed, then can be calculated by a microprocessor in the receiver.

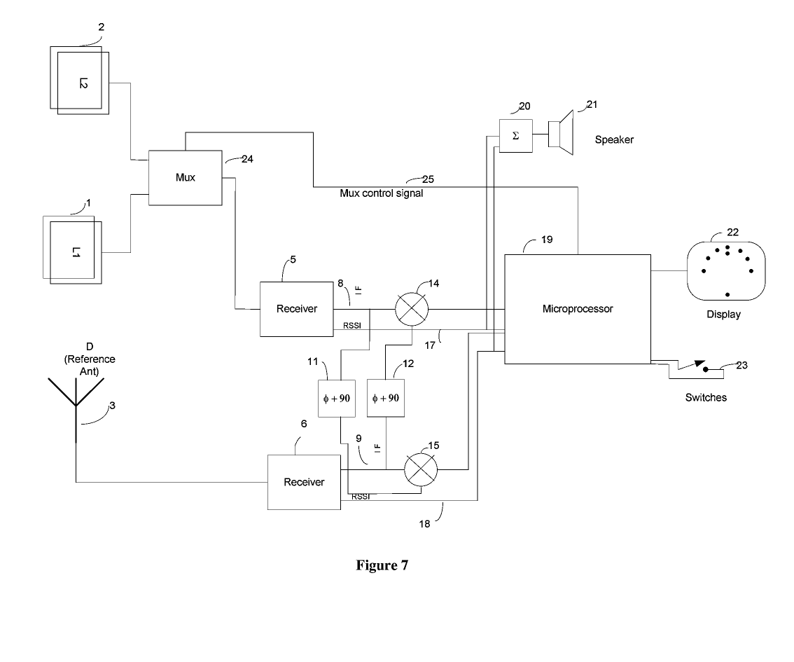

In typical examples, two medium-loop antennas are employed in combination with a reference antenna (typically a dipole antenna), and a direct-phase comparison of the signal from the antennas is performed. In many variations, the phase characteristics of two medium-loop antennas are used in conjunction with a reference antenna in order to determine the originating direction of a received RF signal. FIG. 7 depicts one embodiment of an alternate electronics arrangement, wherein double-frequency phase response and resultant increase in accuracy in bearing are not needed, or is calculated in the microprocessor 19 from the D*(L2+90 degrees) and L1*(D+90 degrees) signals. In this case, a multiplexor 24 is used to receive the outputs of both loop antennas 1, 2 and select which signal is routed to the receiver 5, depending on the multiplexor control signal 25 coming from the microprocessor 19. As can also be observed, an L2*L1 phase comparator is not utilized in this embodiment. In addition, in some variations of this embodiment, two 90-degree phase shifters 11 and 12 are used. However, in still other variations, only one phase shifter 12 is used as an input to its respective comparator 14, while the other phase shifter 11 and its respective comparator 15 can be omitted and the microprocessor 19 can generate the same information. The main idea behind these alternate configurations, such as that depicted in FIG. 7, is to simply reduce the receiver circuit size by roughly one-third, while still substantially maintaining the functionality of the receiver circuit depicted in FIG. 6.

In FIG. 6, each antenna has its own RF receiver 4, 5, 6. In FIG. 7, the loop antenna 1, 2 signals are multiplexed using an analog RF switch 24, by the control signal 25 into a single receiver 5 after which it is compared 14, 15 against the reference antenna 3. Note that in this configuration it is not possible to directly multiply L1 1*L2 2 in the circuit; however, the result can be calculated in the microprocessor 19 using the two other signals that are being compared, L1*(D+90 degrees) and D*(L2+90 degrees).

Because the L1 1 and L2 2 signals are compared to a reference signal, D 3, it is possible to back out the phase outputs of L1 1 and L2 2. Once the phases of L1 1 and L2 2 are known, it is possible to calculate L2*(L1+90 degrees) in the microprocessor 19. In such a case, the third signal is a microprocessor 19 internally-generated third bearing angle signal, which can be used in the same way as the third bearing angle signal generated by the phase comparator 13 in FIG. 6.

### Fourth Embodiment

### A Three-Antenna RF-Direction-Finding Receiver Using Small-Loop Antennas

This embodiment is directed generally to a direction-finding receiver that determines the originating direction of the received radio-signal source, which in some variations is adapted to be readily portable, similar to those disclosed in the Second and Third Embodiments, described supra. However, unlike the Second and Third Embodiments, the system of this embodiment uses only small-loop antennas for its loop antennas.

When only small loop antennas are used in a three-antenna system, a loss in resolution will be the result, since the phase response of the small loop antennas is either zero degrees or 180 degrees as shown in FIG. 1C. Even so, such a system can still be used to determine the direction of the signal without ambiguity, while also presenting the advantage of having a more-compact and portable physical design. For a system with two small-loop antennas, with each of those small-loop antennas having the outputs inverted from each other, a third bearing angle signal between the two loop antennas can be developed which changes at twice the rate of the incident RF angle. The resultant double-frequency output can be used to get a more accurate directional accuracy.

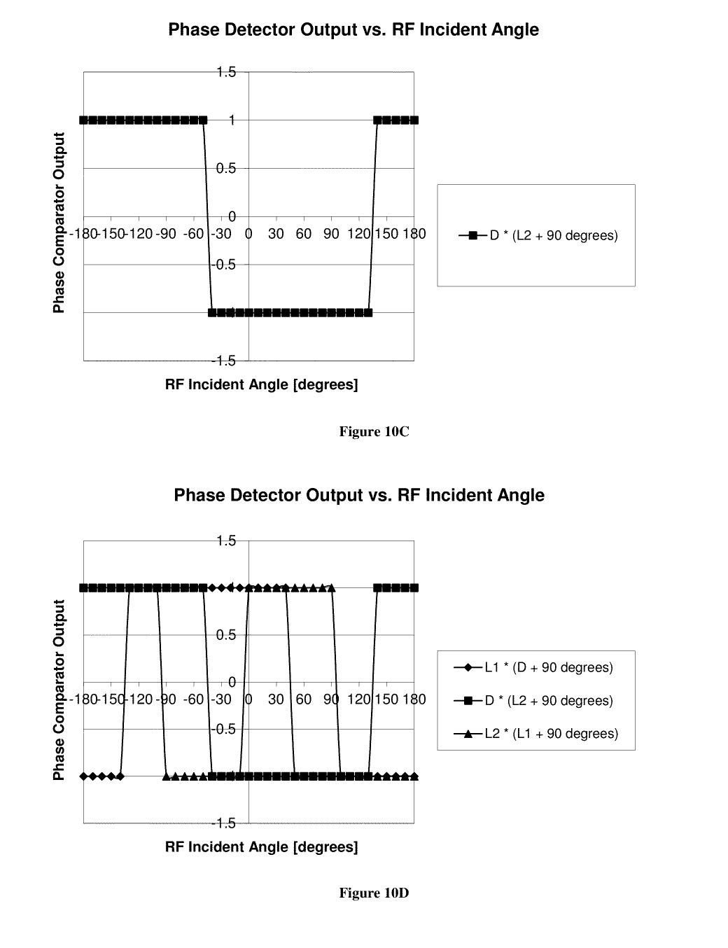

See FIGS. 10A-10D, which shows graphs of typical phase-detector outputs versus the incident RF angle for a system of this type. In particular, FIG. 10D shows the relationship between the three different phase-comparator outputs on a single graph and that there is an abrupt phase change every 45 degrees. Because of the use of small loop antennas, the resolution of the direction is only 45 degrees. By using the abrupt phase transition, it is possible to determine the precise direction of the source of the incident RF signal at the transition points. Conversely, if the outputs of the two small-loop antennas are not inverted relative to each other, the phase comparison of L2*(L1+90 degrees) becomes a constant and thus the third bearing angle signal would not be useful for the determination of the incident RF angle. In this case, the resolution of the direction is only 90 degrees.

### Alternative Embodiments and Other Variations

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising a myriad of obvious variations and improvements to the invention, all of which are intended to be encompassed within the scope of the claims which follow.

What is claimed is:

1. An apparatus for determining the bearing angle, in an x-y-z Cartesian coordinate system, with respect to said apparatus, to a transmitter emitting a predetermined radio signal, with apparatus and transmitter in an x-y plane, comprising:
a first loop antenna responsive to said predetermined radio signal by generating, a first loop output signal,
wherein the winding[s] of said first loop antenna are in a plane perpendicular to said x-y plane, and
wherein the phase of said first loop output signal varies as said apparatus is rotated about the z axis; and
a reference antenna responsive to said predetermined radio signal by generating, a reference output signal,
wherein the phase and amplitude of said reference output signal does not vary substantially as said apparatus is rotated about said z axis; and
a first phase comparator directly responsive to the phase difference between said first loop output signal and said reference output signal, generating a first bearing angle signal.

2. The apparatus of claim 1, further comprising right, left and center directional indicators:
wherein said right and left directional indicators are responsive to said first bearing angle signal, and
wherein said first loop antenna is of an electrical size of a small-loop or a medium-loop, and
wherein a loop antenna of small-loop electrical size is defined as a loop antenna that responds primarily to the magnetic field and a loop antenna of medium-loop electrical size is defined as a loop antenna that responds to both the magnetic and electric field.

3. The apparatus of claim 1, further comprising:
a second loop antenna responsive to said predetermined radio signal by generating a second loop output signal,
wherein the winding[s] of said second loop antenna are in a plane perpendicular to said x-y plane, and
wherein said second loop antenna is oriented at a non-zero-degree angle and within +/−90 degrees relative to said first loop antenna, and
wherein the phase of said second loop output signal varies as said apparatus is rotated about said z axis, and
wherein said first loop antenna and said second loop antenna are of an electrical size of medium-loop, and
wherein a loop antenna of medium-loop electrical size is defined as a loop antenna that responds to both the magnetic and electric field; and
a second phase comparator directly responsive to the phase difference between said second loop output signal and said reference output signal, generating a second bearing angle signal.

4. The apparatus of claim 3, including means of signal inversion of said second loop antenna,
wherein said second loop antenna output is inverted from said first loop antenna by using one of the inverting means: reversing the loop winding direction with respect to the first loop antenna, reversing the output terminal of the second antenna with respect to the first loop antenna or inverting the output signal of the second antenna output when compared to said first loop antenna.

5. The apparatus of claim 4, comprising a third phase comparator directly responsive to the phase difference between said first loop output signal and said second loop output signal, generating a third bearing angle signal,
wherein the addition of said third bearing angle signal substantially doubles the directional sensitivity as compared to the directional sensitivity of an apparatus that relies only on said first and second bearing angle signals.

6. The apparatus of claim 5, further comprising a microprocessor that is responsive to said first, second, and third bearing angle signals, generating a unified bearing angle signal based on said first, second and third bearing angle signals.

7. The apparatus of claim 6, further comprising directional indicators responsive to said unified bearing angle signal.

8. The apparatus of claim 1, further comprising:
a second loop antenna responsive to said predetermined radio signal by generating a second loop output signal,
wherein the winding[s] of said second loop antenna are in a plane perpendicular to the x-y plane, and
wherein said second loop antenna is oriented at a non-zero-degree angle and within +/−90 degrees relative to said first loop antenna, and
wherein the phase of said second loop output signal varies as said apparatus is rotated about said z axis, and
wherein said first loop antenna and said second loop antenna are of an electrical size of small-loop, and
wherein a loop antenna of small-loop electrical size is defined as a loop antenna that responds primarily to the magnetic field; and
means of signal inversion of said second loop antenna,
wherein said second loop antenna output is inverted from said first loop antenna by using one of the inverting means: reversing the loop winding direction with respect to the first loop antenna, reversing the output terminal of the second antenna with respect to the first loop antenna or inverting the output signal of the second antenna output when compared to said first loop antenna; and
a second phase comparator directly responsive to the phase difference between said second loop output signal and said reference output signal, generating a second bearing angle signal, and
a third phase comparator directly responsive to the phase difference between said first loop output signal and said second loop output signal, generating a third bearing angle signal,
wherein the addition of said third bearing angle signal substantially doubles the directional sensitivity as compared to the directional sensitivity of an apparatus that relies only on said first and second bearing angle signal,

9. The apparatus of claim 8, further comprising a microprocessor that is responsive to said first, second, and third bearing angle signals, generating a unified bearing angle signal based on said first, second and third bearing angle signals.

10. The apparatus of claim 9, further comprising directional indicators responsive to said unified bearing angle signal.

11. A method for making an apparatus for determining the bearing angle, in an x-y-z Cartesian coordinate system, to a transmitter emitting a predetermined radio signal, with said apparatus and said transmitter in an x-y plane comprising:
providing a first loop antenna responsive to said predetermined radio signal by generating, a first loop output signal,
wherein the winding[s] of said first loop antenna are in a plane perpendicular to said x-y plane, and
wherein the phase of said first loop output signal varies as said apparatus is rotated about the z axis; and
providing a reference antenna responsive to said predetermined radio signal, by generating a reference output signal,
wherein the phase and amplitude of said reference output signal does not vary substantially as said apparatus is rotated about the z axis; and
providing a first phase comparator directly responsive to the phase difference between said first loop output signal and said reference output signal, generating a first bearing angle signal.

12. The method of claim 11, further comprising:
providing right, left and center directional indicators,
wherein said right, left and center directional indicators are responsive to said first bearing angle signal, and
wherein said first loop antenna is of an electrical size of a small-loop or a medium-loop, and
wherein a loop antenna of small-loop electrical size is defined as a loop antenna that responds primarily to the magnetic field and a loop antenna of medium-loop electrical size responds to both the magnetic and electric field.

13. The method of claim 11, further comprising:
providing a second loop antenna responsive to said predetermined radio signal by generating a second loop output signal,
wherein the winding[s] of said second loop antenna are in a plane perpendicular to said x-y plane, and
wherein said second loop antenna is oriented at a non-zero-degree angle and within +/−90 degrees relative to said first loop antenna, and
wherein the phase of said second loop output signal varies as said apparatus is rotated about said z axis, and
wherein said first loop antenna and said second loop antenna are of an electrical size of medium-loop, and
wherein a loop antenna of medium-loop electrical size is defined as a loop antenna that responds to both the magnetic and electric field; and
providing a second phase comparator directly responsive to the phase difference between said second loop output signal and said reference output signal, generating a second bearing angle signal.

14. The method of claim 13, further comprising:
providing means of signal inversion of said second loop antenna,
wherein said second loop antenna output is inverted from said first loop antenna by using one of the inverting means: reversing the loop winding direction with respect to the first loop antenna, reversing the output terminal of the second antenna with respect to the first loop antenna or inverting the output signal of the second antenna output when compared to said first loop antenna.

15. The method of claim 14, further comprising:
providing a third phase comparator directly responsive to the phase difference between said first loop output signal and said second loop output signal, generating a third bearing angle signal;
wherein the addition of said third bearing angle signal substantially doubles the directional sensitivity as compared to the directional sensitivity of an apparatus that relies only on said first and second bearing angle signals.

16. The method of claim 15, further comprising:
providing a microprocessor responsive to said first and second bearing angle signals by generating a unified bearing angle signal based on said first and second bearing angle signals.

17. The method of claim 16, further comprising:
providing directional indicators responsive to said unified bearing angle signal.

18. The method of claim 11, further comprising:
providing a second loop antenna responsive to said predetermined radio signal by generating a second loop output signal,
wherein said second loop antenna is oriented at a non-zero-degree angle and within +/−90 degrees relative to said first loop antenna, and
wherein said second loop antenna is positioned such that the phase of said second loop output signal varies as said apparatus is rotated about said z axis, and
wherein said second loop antenna output is inverted from the said first loop antenna by using one of the methods: reversing the loop winding direction, reversing the output terminal or inverting the signal when compared to said first loop antenna, and
wherein said first loop antenna and said second loop antenna are of an electrical size of small-loop or magnetic antennas, and
wherein a loop antenna of small-loop electrical size is defined as a loop that responds primarily to the magnetic field; and
providing a second phase comparator directly responsive to the phase difference between said second loop output signal and said reference output signal, generating a second bearing angle signal; and
providing a third phase comparator directly responsive to the phase difference between said first loop output signal and said second loop output signal, generating a third bearing angle signal.

19. The method of claim 18, further comprising:
providing a microprocessor responsive to said first, second, and third bearing angle signals, generating a unified bearing angle signal based on said first, second and third bearing angle signals.

20. The method of claim 19, further comprising:
providing directional indicators responsive to said unified bearing angle signal.

21. The method of claim 12, wherein said transmitter source is selected from the group consisting of Emergency Position-Indicating Radio Beacons (EPIRBs), Emergency Location Transmitters (ELTs), and personal location devices.

22. The method of claim 17, wherein said transmitter source is selected from the group consisting of Emergency Position-Indicating Radio Beacons (EPIRBs), Emergency Location Transmitters (ELTs), and personal location devices.

23. The method of claim 20, wherein said transmitter source is selected from the group consisting of Emergency Position-Indicating Radio Beacons (EPIRBs), Emergency Location Transmitters (ELTs), and personal location devices.
